(19) United States
(12) Patent Application Publication
(10) Pub. No.: US 2012/0160207 A1
(43) Pub. Date: Jun. 28, 2012

(54) BEARING SHELL WITH IMPROVED SIDE LOAD CAPABILITY

(75) Inventor: Bradley J. Shaffer, Romney, IN (US)

(73) Assignee: Caterpillar Inc., Peoria, IL (US)

(21) Appl. No.: 12/976,259

(22) Filed: Dec. 22, 2010

(51) Int. Cl. F02F 7/00; F16C 17/00; F16C 9/02

(52) U.S. Cl. 123/195 R; 384/294; 384/129

(57) ABSTRACT

An engine bearing shell with improved side load capability is disclosed. The engine bearing includes an upper bearing shell having a first single side relief portion. The engine bearing also includes a lower bearing shell having a second side relief portion. The upper bearing shell and the lower bearing shell may be assembled to form a cylindrical bore that is disposed therebetween. The first and second single side relief portions are configured to compensate for any offset shift that occurs at parting lines located between the assembled upper and lower bearing shells.

### TECHNICAL FIELD

The present disclosure relates generally to engine bearings, and more particularly, to an internal combustion engine system and method that employs engine bearing shells.

### BACKGROUND

Engine parts start to wear as heat increases. Friction causes heat. Engine bearings are used to decrease friction, heat and wear. Engine bearings, such as split-half bearings, are conventionally constructed in two parts i.e., an upper half bearing shell and a lower half bearing shell. Together, the upper and lower half bearing shells form a bearing shell.

Bearing shells provide a contacting surface on which a revolving part (e.g., a crankshaft) rests. Such bearing shells are preliminarily mounted in a crankcase, prior to insertion of the crankshaft, such that the upper half shell is positioned in the upper half of the crankcase (engine block portion) and the lower half shell is positioned in the lower half of the crankcase (bearing cap or cover portion). When the engine block portion and the bearing cap portions are tightened, the ends of the upper and lower half bearings are pushed together or force fit, and the bearings are forced into a bearing bore. Such force fit is usually referred to as a “bearing crush”. The resulting bearing bore also helps define the diameter measurement of a cylinder in a piston engine.

However, such bearing crush can cause the upper and lower half bearing shells to become misaligned at a parting line. The parting line refers to the area where the two bearing halves join together.

More specifically, for example, the bores formed within the engine block and bearing cap may be slightly misaligned. As such, the upper and lower half shells of the bearing, when joined together, may also be misaligned. The sharp edges that result from such misalignment may remove or scrape off lubricants from the rotating crankshaft.

As a result, such misalignment have conventionally required removal, during or after manufacture, of materials at the ends or sides of the bearing shells in order to avoid introduction of a sharp edge that can be disposed to scrape needed lubrication oil off of rotating parts. Although such conventional relief of material solution may reduce lubrication issues caused by misalignment, the removal of bearing material indiscriminately from various locations greatly decreases the load carrying capabilities of such bearing shells. As one example, belt driven loads powered by an engine and located at a side of the engine may produce loads that are concentrated at the sides, or parting lines, of the bearing shells. Due to the decreased load carrying capabilities that result from relieved material removal, such bearing shells are susceptible to being incapable of supporting such side loads and, as a result, may be damaged.

Thus, conventional techniques of indiscriminately relieving, or removing bearing material from bearing shells at various locations to achieve smooth, low-friction movements between surfaces have resulted in engine failures. It is therefore desirable to provide, among other things, an improved bearing shell.

### SUMMARY OF THE INVENTION

In accordance with one embodiment, the present disclosure is directed to an engine bearing. The engine bearing includes an upper bearing shell having a first single side relief portion. The engine bearing also includes a lower bearing shell having a second single side relief portion. The upper bearing shell and the lower bearing shell can be assembled to form an approximately cylindrical bore that is disposed therebetween. The first and second single side relief portions are configured to compensate for any offset shift that occurs at parting lines located between the assembled upper and lower bearing shells.

In another embodiment, the present disclosure is directed to an internal combustion engine having an engine block configured to receive an upper bearing shell. The upper bearing shell includes a first single side relief portion. The internal combustion engine also includes a bearing cap configured to receive a lower bearing shell. The lower bearing shell includes a second single side relief portion. The engine block and the bearing cap also include an assembled configuration such that the upper bearing shell and the lower bearing shell define an approximately cylindrical bore in the assembled configuration. The first and second single side relief portions are configured to compensate for any offset shift that occurs at a parting line disposed between the upper and lower bearing shells.

In another embodiment, the present disclosure is directed to a method of desensitizing bearing support to effects of engine block and bearing cap misalignment in an internal combustion engine. The method includes positioning an upper bearing shell within a recess of the engine block. The upper bearing shell includes a first single side relief portion. The method also includes positioning a lower bearing shell within a recess of the bearing cap. The lower bearing shell includes a second single side relief portion. Further, the method includes assembling the engine block and the bearing cap.

### BRIEF DESCRIPTION OF THE DRAWINGS

FIG. 1 illustrates an engine bearing housed in a crankcase of an internal combustion engine.

FIG. 2 illustrates misalignment at a junction of an engine block and bearing cap in an internal combustion engine.

FIG. 3 illustrates a zoomed-in portion of selective single side relief applied to a single portion of an upper bearing shell and to a single portion of a lower bearing shell.

FIG. 4 illustrates a polar plot showing effects on a conventional bearing shell having side relief applied at four locations of the upper and lower bearing shells.

FIG. 5 illustrates a polar plot showing the effects on a bearing shell having selective side relief applied only where needed, in accordance with one embodiment of the engine bearing.

FIG. 6 illustrates an embodiment of a bearing shell having flat side surfaces.

FIG. 7 illustrates in flow-chart form a method for desensitizing bearing support to effects of engine block and bearing cap misalignment in an internal combustion engine.

### DETAILED DESCRIPTION

Reference will now be made in detail to exemplary embodiments, which are illustrated in the accompanying drawings. Wherever possible, the same reference numbers will be used throughout the drawings to refer to the same or like parts.

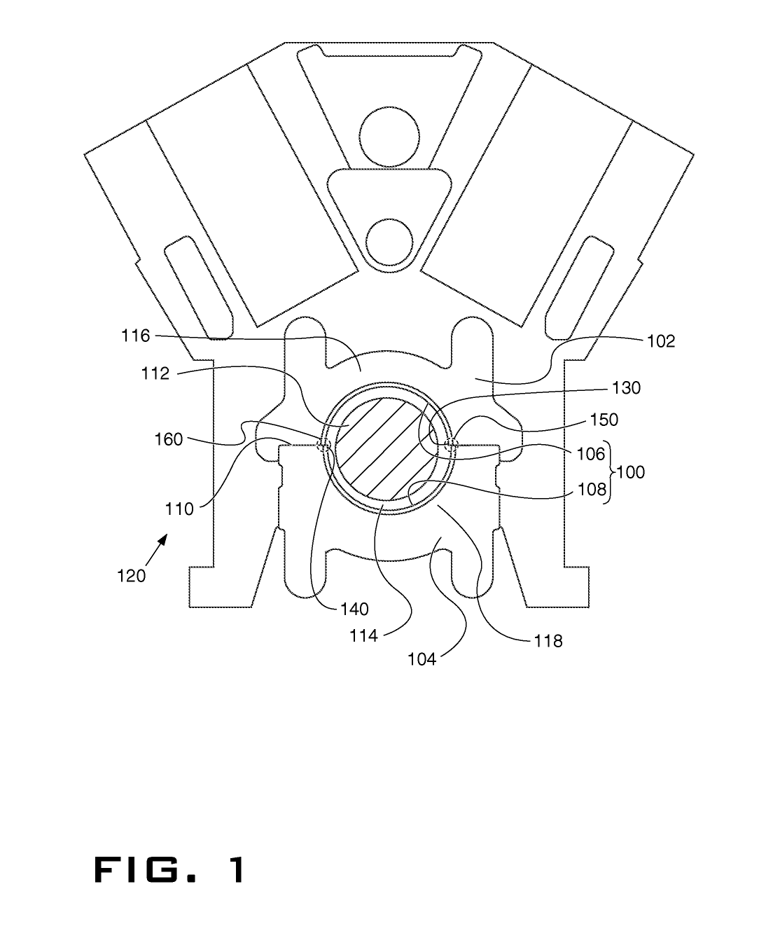

FIG. 1 illustrates a cross-section of an internal combustion engine that includes an engine bearing 100 housed within a crankcase of an internal combustion engine 120. The engine bearing 100 includes an upper bearing shell 106 and a lower bearing shell 108. The upper bearing shell 106 and the lower bearing shell 108 may be assembled to form a cylindrical bore 112 that is disposed therebetween. However, during manufacture or assembly of the engine bearing cap 104 or the assembly and crush of, the upper bearing shell 106 and the lower bearing shell 108 may be misaligned at regions 150, 160. Thus, selective single side relief 130, 140 may be applied, respectively, to a selected portion of the upper bearing shell 106 and a selected portion of the lower bearing shell 108. Such selective single side relief portions 130, 140 that are applied to a selected portion of the upper bearing shell 106 and the lower bearing shell 108 are configured to compensate for any preselected rotation direction of journal 114 and offset shift that may occur at parting lines 110 located between the assembled upper and lower bearing shells 106, 108. In one example, such first single side relief portion 130 of the upper bearing shell 106 and the second single side relief portion 140 of the lower bearing shell 108 may each include removed bearing material.

The engine bearing 100 is a definable structure that provides improved oil lubrication throughout an engine employing single side relief to a selective portion of a bearing. Such improved oil lubrication helps prevent scraped off oil-related bearing failures that may result from oil starvation by providing sufficient oil between, for example, the crankshaft journal 114 and the bearing. The oil that flows to the bearings forms an oil film between the crankshaft journal and the bearing. Rotation of the crankshaft journal tends to force oil between the journal and the bearing and, during normal operation, prevents metal-to-metal contact as the pressurized oil develops. Lack of lubrication or oil starvation may cause metal-to-metal contact, increased friction, and higher temperatures that can lead to the bearing seizing to the shaft. In extreme cases, the bearings surface may adhere tightly, or seize, and thus, cause the crankshaft surface to be completely destroyed.

In one example, the engine bearing 100 includes the first single side relief portion 130 of the upper bearing shell 106 and the second side relief 140 portion of the lower bearing shell 108 such that the first and second single side relief portions 130, 140 are diametrically opposed relative to the cylindrical bore 112. The cylindrical bore 112 defines the measurements of the journal diameters in an engine. As used herein, the parting line refers to a mark that results when the engine block portion 102 and the bearing cap portion 104 are tightened, thereby causing the ends of the upper and lower half bearings 106, 108 to be pushed together or force fit so that the bearings are forced into a bearing bore 112. Such force fit may also cause frictionally gripping of the half shells 106, 108 to bores 116 and 118.

In another example, the first single relief portion 130 and the second single relief portion 140 are respectively provided on internal surfaces of the upper and lower bearing shells 106, 108. In another example, the first single side relief portion 130 of the upper bearing shell 106 and the second single side relief portion 140 of the lower bearing shell 108 can be provided on external surfaces thereof.

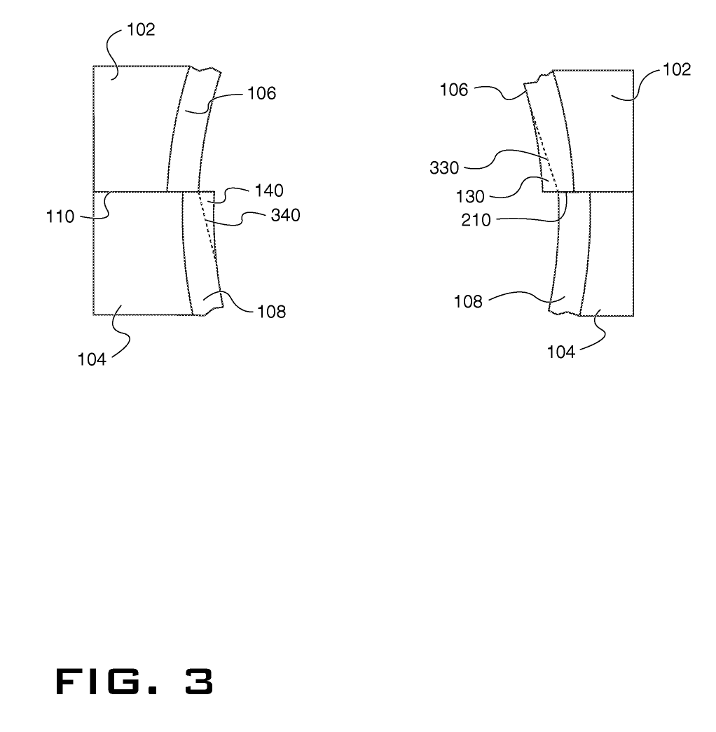

In another example, the first single side relief portion 130 of the upper bearing shell 106 and the second single side relief portion 140 of the lower bearing shell 108 may each include an approximately planar surface 330, 340. (See FIG. 3 infra). The planar surface 330 of the upper bearing shell 106 and the planar surface 340 of the lower bearing shell 108 can be configured to be circumferentially spaced from a parting line 110. In yet another example, in the assembled configuration of the engine bearing, the first single side relief portion 130 of the upper bearing shell 106 and the second single side relief portion 140 of the lower bearing shell 108 are positioned on opposing sides of the parting line 110.

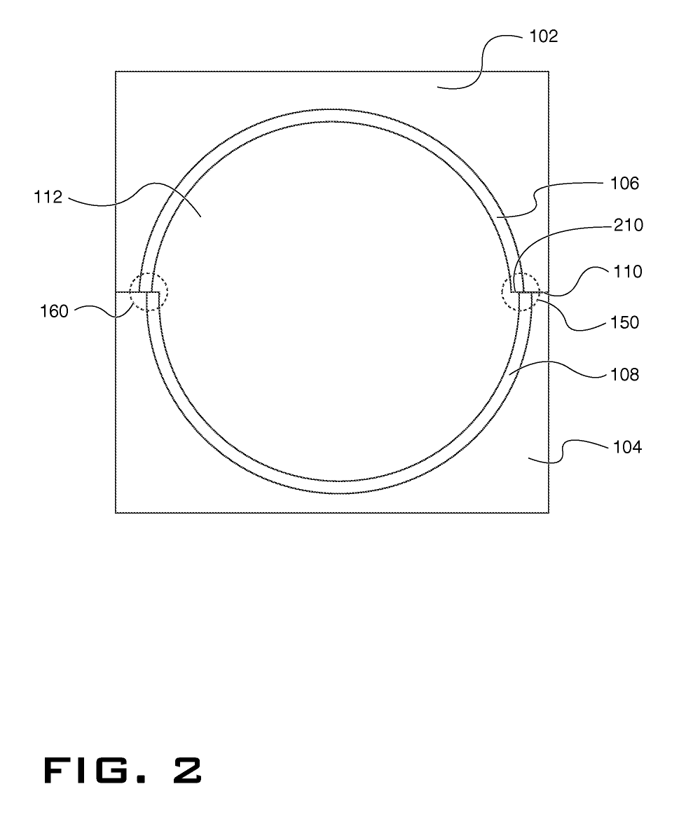

FIG. 2 illustrates misalignment at a junction of an engine block and bearing cap in an internal combustion engine. To alleviate effects of such misalignment, side relief may be required to be applied at selective portions of the upper bearing shell 106 and lower bearing shell 108. In one embodiment, the engine block 102 can be configured to receive the upper bearing shell 106. Also, the bearing cap 104 can be configured to receive a lower bearing shell 108. Due to engine block manufacturing, or bearing manufacturing, or assembling issues, the engine block 102 and the bearing cap 104 may become misaligned at the parting line 110. This can cause the upper and lower bearing shells 106, 108 to be misaligned at the parting line 210, where the bearing halves 106, 108 join together. Further, the tightening assembly of the cap 104 to the block 102 may crush the half shells 106, 108 causing each at the parting line 112 to bulge, or protrude into bore 112. Therefore, the bore 112 formed within the engine block 102 and the bearing cap 104 may become misaligned and deformed out of a preselected approximately cylindrical shape. As such, the upper bearing shell 106 and the lower bearing shell 108, when joined together at parting line 210, may also be misaligned in regions 150 and 160. Sharp edges that can result from such misalignment may scrape off, or remove necessary lubrication from a rotating journal 114 operating within the bore 112.

Conventional means of eliminating such sharp edges results in decreased the load capabilities of the bearing shells. As one example, belt driven loads powered by the engine and located at a side of the engine may produce loads concentrated at the sides or at areas proximate to the parting lines 110, 210. With the decreased load capabilities resulting from material removal, bearing shells in the areas of decreased thickness are not capable of supporting such loads and, as a result, may be damaged.

FIG. 3 illustrates a zoomed-in portion of selective side relief applied to a single portion of the upper bearing shell 106 and a single portion of the lower bearing shells 108. In one embodiment, the engine block 102 and the bearing cap 104 have an assembled configuration such that the upper bearing shell 106 and the lower bearing shell 108 define a smoother cylindrical bore 112 in the assembled configuration. Such smoother cylindrical bore 112 can be achieved by a first single side relief portion 130 being applied to only one portion of the upper bearing shell 106, and a second single side relief portion 140 being applied to only one portion of the lower bearing shell 108. As such, the first and second single side relief portions 130, 140 are configured to compensate for any offset shift that occurs at a parting line 210 disposed between the upper bearing shell 106 and the lower bearing shell 108. Such selective single side relief portions 130, 140 being applied to only one portion of both the upper bearing shell 106 and lower bearing shell 108 alleviates issues arising from decreased load capabilities that may result due to materials being scraped at multiple portions of each of the upper and lower bearing shells 106, 108. Thus, for a counter-clockwise rotating journal 114, material may be removed only from the left side of the lower bearing shell 108 and only from the right side of the upper bearing shell 106, in order to eliminate sharp edges along the respective rotation paths. It is noteworthy, that the converse applies for a clockwise rotation of the crankshaft.

In one example, an internal combustion engine may be configured such that the first single side relief portion 130 of the upper bearing shell 106 and the second side relief portion 140 of the lower bearing shell 108 are diametrically opposed relative to the cylindrical bore 112. The first single relief portion 130 and the second single relief portion 140 may be respectively provided on internal surfaces of the upper and lower bearing shells 106, 108. In an assembled configuration, the first single side relief portion 130 of the upper bearing shell 106 and the second single side relief portion 140 of the lower bearing shell 108 may be disposed on opposing sides of the parting line 210 of the upper bearing shell 106 and the lower bearing shell 108. Such parting line 210 of the upper bearing shell 106 and the lower bearing shell 108 may be disposed substantially parallel to another parting line 110 that may be disposed between the engine block 102 and the bearing cap 104. Also, in another embodiment, the first single side relief portion 130 of the upper bearing shell 106 and the second single side relief portion 140 of the lower bearing shell 108 can be provided on external surfaces thereof. The first single side relief portion 130 of the upper bearing shell 106 and the second single side relief portion 140 of the lower bearing shell 108 may each be configured as an approximately planar surface. Such planar surface 330 of the upper bearing shell 106 and the planar surface 340 of the lower bearing shell 108 may be circumferentially spaced from the parting line 210 disposed between the upper and lower bearing shells 106, 108.

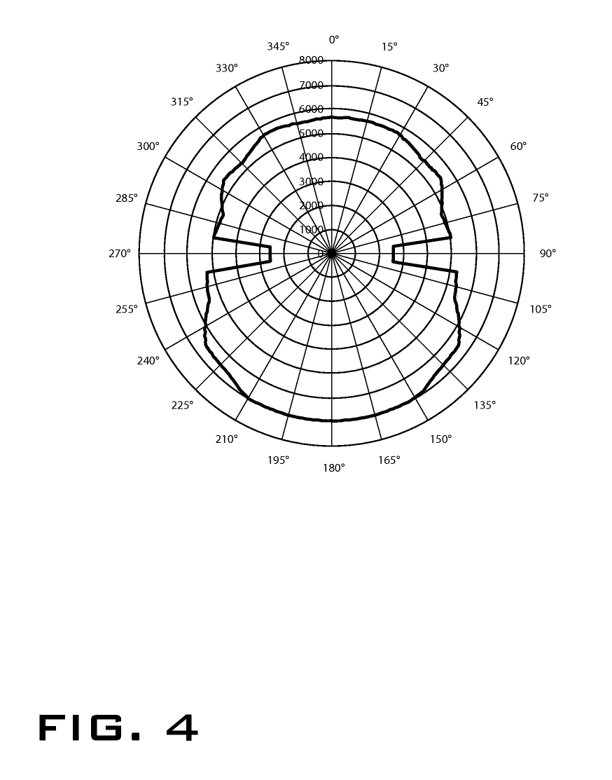

FIG. 4 illustrates a polar plot showing effects on a conventional bearing shell having side relief applied at four locations of the upper and lower bearing shells. It is noteworthy that having side relief applied at four locations permits the journal 114 to rotate clockwise or counter-clockwise without presenting a sharp edge, which scraps off oil from the bore 112. As shown by the polar plot in FIG. 4, such side relief is applied at the top-left and top-right locations of the upper bearing shell, and the bottom-left and bottom-right of the lower bearing shell.

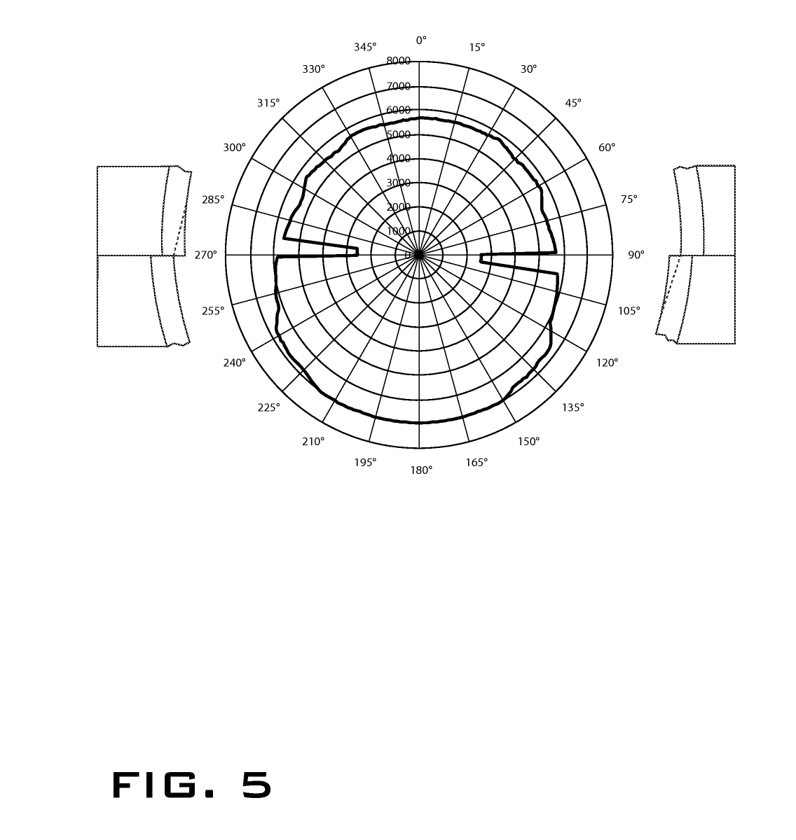

FIG. 5 illustrates a polar plot showing the effects on a bearing shell having selective side relief applied only where needed, in accordance with one embodiment of the engine bearing. As one example, for a clockwise rotating crankshaft, FIG. 5 shows side relief selectively applied at only two locations of the bearing shell i.e., only at the top-left location of the upper bearing shell, and only at the bottom-right location of the lower bearing shell.

Polar plots illustrated in FIGS. 4 and 5, provide information to evaluate the load-carrying capabilities of a bearing shell having different applications of side relief being applied to only selective portions of the upper and lower bearing shells 106, 108. A polar plot represents a two-dimensional coordinate system in which a distance from a fixed point and an angle from a fixed direction determine each point on a plane. More specifically, the permissible load carrying capacity metric of an engine bearing shell is presented herein as a polar plot, wherein the load angle is measured clockwise when viewed from the front of the engine. Load (N) acts radially outwards. In FIG. 5, for a clockwise rotating crankshaft, material may be removed only from the right side of the lower half bearing shell and the left side of the upper half bearing shell. Such material removal eliminates sharp edges along a clockwise rotation path of a crankshaft and provides increased load capabilities as compared to conventional designs. As shown in the center of the FIG. 5 polar plot between approximately 90 and 98 degrees, and between approximately 270 and 278 degrees, only side load capabilities corresponding to the decreased areas of material removal are reduced. It should be appreciated that for a crankshaft rotating in the counterclockwise direction, material may be removed only from the left side of the lower half shell and the right side of the upper half shell. It can be observed that the bearing shell having side relief at each corner locations (i.e., in FIG. 4) of the upper and lower bearing has less load capabilities because more material is removed from the bearing shells. On the other hand, the bearing shell having selective side relief at only two locations exhibits increased load capabilities because less material is removed from the bearing shells, as represented in FIG. 5.

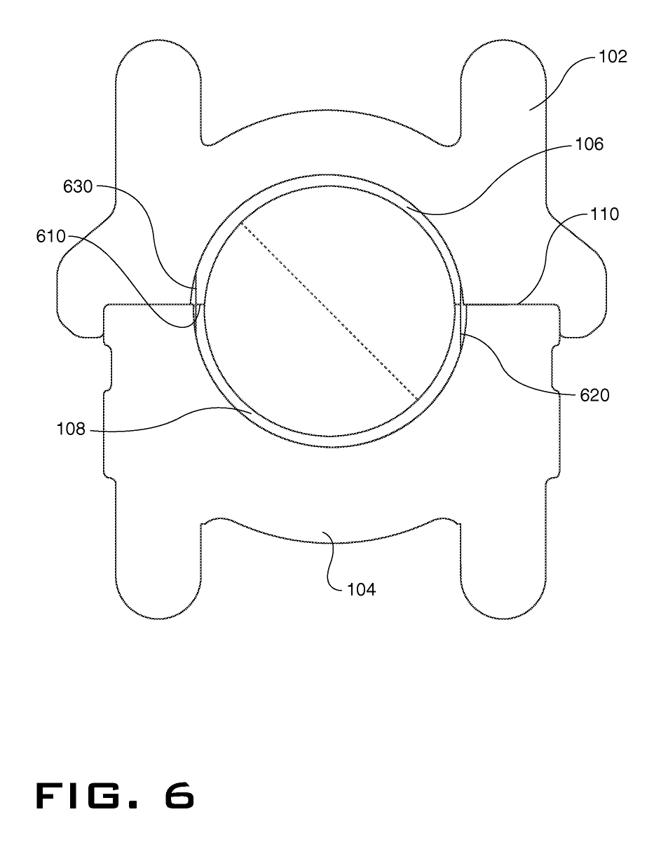

FIG. 6 illustrates another embodiment of a bearing shell having approximately flat side surfaces such that the flat side surfaces may provide sufficient clearance between the bearing shell and the parting line 110 of the engine block 102 and the bearing cap 104 to reduce effects of any misalignment between the two. First flat side surface 620 associated with the upper bearing shell 106 may be disposed at an angle or tangentially to parting line 110. Also, second approximately flat side surface 630 may be disposed at an angle or tangentially to parting line 110. The parting line 610 of the bearing shells may be offset. As can be appreciated, portions of the upper bearing shell 106 and the lower bearing shell 108 defining the first and second flat side surfaces 620, 630 may have a decreased thickness as compared to the other portions of the upper and lower bearing shells. The upper bearing shell 106 and the lower bearing shell 108 may exhibit reduced side load capabilities in those areas of decreased thickness relative to the rest of the bearing shell. In another embodiment, the parting lines of the upper and lower bearing shells 106, 108 can also be offset. As such, the horizontal parting line 610 of the upper bearing shell 106 and the lower bearing shell 108 may be offset such that the upper bearing shell 106 and the lower bearing shell 108 are not joined at the flat side surface 620, 630 areas.

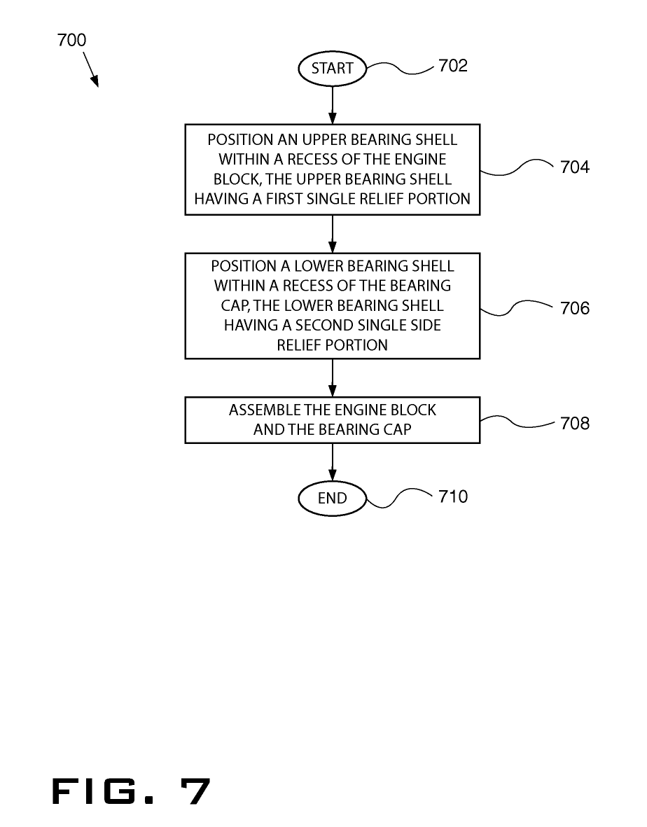

FIG. 7 illustrates in flow-chart form a method for desensitizing bearing support to effects of engine block and bearing cap misalignment in an internal combustion engine as identified at 700. The method starts in operation 702. In operation 704, the upper bearing shell 106 may be positioned within a recess of the engine block 102. The upper bearing shell 106 may be configured with a single side relief portion. In operation 706, the lower bearing shell 108 may be positioned within a recess of the bearing cap 104. The lower bearing shell 108 may be configured with a single side relief portion. In operation 708, the engine block 102 and the bearing cap 104 are assembled. The engine block 102 and the bearing cap 104 can be assembled via, for example, an engine assembler. The process ends in operation 710.

In one example, the method for desensitizing bearing support to effects of engine block and bearing cap misalignment in an internal combustion engine includes positioning an internal side relief portion of the upper bearing shell 106 and an internal side relief portion of the lower bearing shell 108 based on an angle of rotation of the internal combustion engine 120. In another example, the method includes positioning an external planar surface 620 of the upper bearing shell 106 and an external planar surface 630 of the lower bearing shell 108 to each span a discontinuity between the engine block 102 and the bearing cap 104.

### INDUSTRIAL APPLICABILITY

The disclosed engine bearing may be provided in any machine or engine where sufficient lubrication is a requirement. As one example, the engine bearing may be particularly applicable to a definable structure that provides improved oil lubrication throughout an engine. The operation of the engine bearing will now be explained.

During normal operation, engine bearing 100 may be housed in a crankcase of an internal combustion engine 120. The engine bearing 100 can include an upper bearing shell 106 having a first single side relief portion 130. Also, the engine bearing 100 can include a lower bearing shell 108 having a second single side relief portion 140. The upper bearing shell 106 and the lower bearing shell 108 may be assembled to form a cylindrical bore 112 that is disposed therebetween. The first and second single side relief portions 130, 140 are configured to compensate for any offset shift that occurs at parting lines 110 located between the assembled upper and lower bearing shells 106, 108.

Engine bearings 100 employing single side relief to a selective portion of the bearing helps prevent oil-related bearing failures that may result due to oil starvation. As one example, rotation of the crankshaft journal tends to force oil between the journal and the bearing. As such, during normal operation, providing sufficient oil between the crankshaft journal and the bearing helps prevent metal-to-metal contact as the pressurized oil develops. Lack of lubrication or oil starvation may cause metal-to-metal contact, increased friction, and higher temperatures, which may lead to the bearing seizing to the shaft. In extreme cases the bearings surface may adhere so tightly, and thus, causing the crankshaft surface to be completely destroyed.

Moreover, prolonged operation of an engine with insufficient oil film can cause damage to progress quickly to a smeared bearing, then to a scuffed bearing, and finally to a seized bearing. In one example, the first stage of such damage is smearing wherein a bearing may show displacement of the lead-tin overlay that may be disposed in the center of the bearing. In a second stage of damage (i.e., scuffing), the material (e.g., aluminum) located in the center of the bearing may be displaced. The final stages of failure may result in total seizure. In all three stages, the rotating journal displaces some of the veneer, or overlay material from the crown toward the mating face of each bearing half. The amount of displaced material will depend on how severe the lack of lubrication is. As the bearing and journal surfaces wear, clearances increase and oil film thickness changes, resulting in uneven support of the surfaces.

Thus, engine bearing 100 can provide a relatively inexpensive wear items designed to protect the expensive crankshaft, connecting rod and engine block 102. Engine bearings 100 having selective single side relief 130, 140 render such protection by providing a soft, smooth surface with a high load carrying capability. This protects, for example, the crankshaft journal surfaces during engine start-ups and heavy loads. Further, such engine bearing 100 having selective single side relief helps maintain correct oil flow and pressure between parts.

It is contemplated that such engine bearing 100 may be composed of materials such as nickel, bronze, steel to provide thickness; aluminum alloy to provide bearing strength; and copper to provide scuff resistance and to provide bonding material to bond lead-tin and aluminum layers together.

While this disclosure includes particular examples, it is to be understood that the disclosure is not so limited. Numerous modifications, changes, variations, substitutions and equivalents will occur to those skilled in the art without departing from the spirit and scope of the present disclosure upon a study of the drawings, the specification and the following claim

What is claimed is:

1. An engine bearing, comprising:
an upper bearing shell having a first single side relief portion; and
a lower bearing shell having a second side relief portion, the upper bearing shell and the lower bearing shell assembled to form a cylindrical bore disposed therebetween,
wherein the first and second single side relief portions are configured to compensate for any offset shift that occurs at parting lines located between the assembled upper and lower bearing shells.

2. The engine bearing of claim 1, wherein the first single side relief portion of the upper bearing shell and the second side relief portion of the lower bearing shell are diametrically opposed relative to the cylindrical bore.

3. The engine bearing of claim 2, wherein the first single relief portion and the second single relief portion are respectively provided on internal surfaces of the upper and lower bearing shells.

4. The engine bearing of claim 3, wherein, in the assembled configuration, the first single side relief portion of the upper bearing shell and the second single side relief portion of the lower bearing shell are positioned on opposing sides of the parting line.

5. The engine bearing of claim 4, wherein the first single side relief portion of the upper bearing shell and the second single side relief portion of the lower bearing shell each include removed bearing material.

6. The engine bearing of claim 2, wherein the first single side relief portion of the upper bearing shell and the second single side relief portion of the lower bearing shell are provided on external surfaces thereof.

7. The engine bearing of claim 6, wherein the first single side relief portion of the upper bearing shell and the second single side relief portion of the lower bearing shell each include material removed forming an approximately planar surface.

8. The engine bearing of claim 7, wherein the planar surface of the upper bearing shell and the planar surface of the lower bearing shell are circumferentially spaced from a parting line.

9. An internal combustion engine, comprising:
an engine block configured to receive an upper bearing shell, the upper bearing shell having a first single side relief portion; and
a bearing cap configured to receive a lower bearing shell, the lower bearing shell having a second single side relief portion;
the engine block and the bearing cap having an assembled configuration, the upper bearing shell and the lower bearing shell defining a cylindrical bore in the assembled configuration,
wherein the first and second single side relief portions are configured to compensate for any offset shift that occurs at a parting line disposed between the upper and lower bearing shells.

10. The internal combustion engine of claim 9, wherein the first single side relief portion of the upper bearing shell and the second side relief portion of the lower bearing shell are diametrically opposed relative to the cylindrical bore.

11. The internal combustion engine of claim 10, wherein the first single relief portion and the second single relief portion are respectively provided on internal surfaces of the upper and lower bearing shells.

12. The internal combustion engine of claim 11 wherein, in the assembled configuration, the first single side relief portion of the upper bearing shell and the second single side relief portion of the lower bearing shell are disposed on opposing sides of the parting line of the upper bearing shell and the lower bearing shell.

13. The internal combustion engine of claim 12, wherein the parting line of the upper bearing shell and the lower bearing shell is substantially parallel to another parting line disposed between the engine block and the bearing cap.

14. The internal combustion engine of claim 10, wherein the first single side relief portion of the upper bearing shell and the second single side relief portion of the lower bearing shell are provided on external surfaces thereof.

15. The internal combustion engine of claim 14, wherein the first single side relief portion of the upper bearing shell and the second single side relief portion of the lower bearing shell each include removed material forming an approximately planar surface.

16. The internal combustion engine of claim 15, wherein the planar surface of the upper bearing shell and the planar surface of the lower bearing shell are circumferentially spaced from the parting line disposed between the upper and lower bearing shells.

17. The internal combustion engine of claim 15, wherein the planar surface of the upper bearing shell and the planar surface of the lower bearing shell each span a discontinuity between the engine block and the bearing cap.

18. A method of desensitizing bearing support to effects of engine block and bearing cap misalignment in an internal combustion engine, comprising:
positioning an upper bearing shell within a recess of the engine block, the upper bearing shell having a first single side relief portion;
positioning a lower bearing shell within a recess of the bearing cap, the lower bearing shell having a second single side relief portion; and
assembling the engine block and the bearing cap.

19. The method of claim 18, further including:
positioning an internal side relief portion of the upper bearing shell and an internal side relief portion of the lower bearing shell based on an angle of rotation of the internal combustion engine. 20 The method of claim 18, further including:
positioning an external planar surface of the upper bearing shell and an external planar surface of the lower bearing shell to each span a discontinuity between the engine block and the bearing cap.
